(19) United States
(12) Patent Application Publication
(10) Pub. No.: US 2006/0259321 A1
(43) Pub. Date: Nov. 16, 2006

(54) System for automating and managing an enterprise IP environment

(75) Inventors: John J. Gabrick, Pittsburgh, PA (US); Cassius A. Elston JR., Redmond, WA (US)

Correspondence Address: THE LAW OFFICE OF RICHARD W. JAMES, 25 CHURCHILL ROAD, CHURCHILL, PA, 15235, US

(73) Assignee: MindMatters Technologies, Inc.

(21) Appl. No.: 11/491,572

(22) Filed: Jul. 24, 2006

Related U.S. Application Data
(63) Continuation of application No. 09/706,513, filed on Nov. 3, 2000.
(60) Provisional application No. 60/163,877, filed on Nov. 5, 1999.
(60) Provisional application No. 60/165,140, filed on Nov. 12, 1999.

(51) Int. Cl. G06Q 99/00

(52) U.S. Cl. 705/1

(57) ABSTRACT

An intellectual property management method and system. The method and system enter information associated with an innovation, store the information and a date the information was stored in a database, and receive a certification including the information associated with the innovation and the date the information was stored in the database.

### CROSS-REFERENCE TO RELATED APPLICATIONS

The present application is a continuation of U.S. patent application Ser. No. 09/706,513, filed Nov. 3, 2000, which claimed priority from provisional patent applications having Ser, Nos. 60/163,877, filed Nov. 5,1999, and 60/165,140, filed Nov. 12, 1999.

The present application furthermore incorporates U.S. patent application Ser. No. 09/706,513 by reference.

### TECHNICAL FIELD

The invention relates to knowledge management systems; more particularly it relates to systems for automating and managing an enterprise IP environment, with global communications network capabilities.

### BACKGROUND OF THE INVENTION

The significance of intellectual property (IP) is growing daily. More and more, corporations realize the importance of preserving and protecting these vital assets, and a select few even appreciate how to capitalize on them. However, the real underlying issue that has not been addressed, up until now, is that in today's digital enterprise there is a tremendous need for a reliable, real-time system for creating, preserving and building value from corporate IP assets. This model must be in synch with today's digital world and enterprise environment and operate on a continuous, real time basis. It must work transparently with the way in which employees work and innovate. It must be a useful productivity tool for IP attorneys and corporate counselors. And it must safeguard and protect the most valuable assets a company owns, its intellectual capital.

Many companies are only recently recognizing the rise in significance of IP as a core asset. However, even with heightened awareness, most continue to operate in antiquated ways, relying on “defensive mechanisms,” such as legalistic paperwork and cumbersome procedures. These techniques are expensive, time-intensive, and inadequately suited for today's digital environment, since they fail to operate in real time.

Today, very few companies use the potential of information technology to streamline processes, promote new innovation, and document and protect their assets. Often, their employees at just about every level are undereducated and unaware of the risks of inadvertent disclosure or competitive loss—setting the stage for future disputes and often leading to litigation, or even worse, the permanent loss of valuable trade secrets.

Most significantly, virtually all corporations underestimate the strategic value of their IP, and therefore, fail to capitalize on the full potential of it. And even while recognizing the growing significance of IP assets, there are essentially no companies that do an effective job at providing the knowledge-connectivity™ and incentive for new innovations.

In today's job market, employees are more mobile than ever before. Mergers, acquisitions, and downsizing are just a few of the reasons. The result is a constantly changing workforce, and the constant creation, disclosure, and turnover of corporate intellectual property. And whereas it is perfectly legal for a highly skilled employee to leave and go to work with a competitor, taking with him or her his own skills and experience, it is not lawful to leave with proprietary company information.

These trends of higher worker mobility and the increasing value of digital assets have converged to create a tremendous opportunity for a new solution. Companies certainly want to avoid additional litigation nightmares, when even a single trade secret dispute or patent infringement suit can cost well over $1 million in legal fees. Douglas Brotz, principle scientist at Adobe Systems, commenting on a patent infringement suit described how it had cost the company more than $4.5 million in legal fees and expenses alone, not to mention over 3,500 hours of his time—the equivalent of two, full years of working time. Most remarkably, this was a case that Adobe had won, initially and on appeal. Clearly, an effective means for mitigating the risk of a costly lawsuit would be of great benefit to many leading technology companies.

For the most part, individual employees don't want or intend to break trade secret laws, steal proprietary assets or misappropriate secret files. They just want to pursue the opportunities afforded to them in the free marketplace. In many cases, the core issue, the one that becomes highly volatile, is that it is nearly impossible to discern between company IP assets and individual skills and knowledge. Coupled with the fact that companies do a very poor job of identifying their IP assets in the first place—62% of companies have no procedures for reporting information loss. This tension becomes the catalyst for another wasteful lawsuit, pitting the company against ex-employee. The company, quite self-righteously, stakes a claim to a broad range of trade secrets; and the employee, defends by pleading that the information is in the public domain, or part of his general skills and knowledge. Just recently, in another high profile suit that illustrates this growing problem, Motorola, Inc. sued Intel for hiring away a number of its key employees. An Intel spokesperson said the action was taken solely to protect Motorola's intellectual property, which it characterized as its “lifeblood.”

As a further example of the seriousness of this issue, in 1998 the American Society for Industrial Security (ASIS) reported that IP losses for U.S. companies might exceed $250 billion annually. Furthermore, five times more companies feel the issue of intellectual property loss is increasing. With the nation's competitiveness riding on our ability to maintain technological superiority, losing trade secrets can be devastating. What makes matters worse is that most companies don't know, nor have they taken action to find out what their specific trade secrets are, and whether or not they are legally protected. This only adds to the potential of a future lawsuit, since only a lengthy hearing of the facts can ultimately determine the “right and wrong.”

Slow, expensive and outmoded legal precautions, and time-consuming audits are not the answer in this day and age of rapid product development. To keep their competitive edge, and to promote innovation and capitalize on knowledge assets, there is a need for a new solution—an innovative way of managing IP property.

In the past, intellectual property was not as pressing an issue as it has now become. The connection between an idea and the creation of wealth was less direct, and the road from the one to the other was traveled at a more leisurely pace. By contrast, in today's information-intensive economy, that connection is immediate and intense. Knowledge is now the driving force behind innovation and the creation of new wealth.

Within many of today's companies, innovation fuels high market caps, not tangible assets as in the past. The trends of higher worker mobility and widespread litigation, coupled with the increasing value of digital assets have converged to create a tremendous opportunity for a new solution.

Need for an Innovation Management System

The preponderance of adjectives such as “monitoring,” “protection,” “litigation,” and “security” immediately conjures up images of “Big Brother.” And while proper oversight cannot and should not be ignored, this functionality in and of itself fails to address an even more important issue: How effectively do companies promote innovation? After all, if you accept the fact that IP is becoming more and more critical, then shouldn't companies treat it like their corporate lives depend upon it?

Most companies do very little to tap into the vast resources of knowledge that exist inside their own organizations. One Fortune 100 Company offers a $100 dinner-for-two award for new ideas submitted by email to the corporate counselor. That's not much of an incentive, when you consider the other options available to today's employees, especially those with an entrepreneurial drive, and the ready supply of venture capital that exists.

Many of these companies rely on a perceived underlying expectation that their employees will automatically produce new innovations, as if obligated merely by the fact that they receive a paycheck and benefits. And most companies employ legal covenants that dictate the assignment of new ideas to the company, if developed on company time, with company resources, or which relate to the company's business. That mindset may have worked a generation ago, but it doesn't meet today's needs, or work for today's dynamic job market. After all, who gets to decide where one idea starts and ends? Who owns an idea that may not have been reduced to practice by the employee while he worked for the company? Ownership issues can destroy the potential of a new concept before it gets off the blocks.

It just does not appear that legal pressure is the best way to promote the creation of new ideas. Nor does it appear that employees, particularly the most savvy ones, will naively turn over their best and brightest ideas without some reasonable incentive or recognition, especially as they become more aware of the potential value. Considering that the ideas that gave birth to over 70% of the country's 100 fastest growing companies came from previous employment, it is easy to appreciate the significance of this issue. Today, most companies fail to recognize this, and consequently, they wonder why some of their best talent leaves to pursue other opportunities—including business ideas that they originated while working for their previous employer.

A recent survey published in the Harvard Business Review reported that “71% of entrepreneurs responsible for starting the country's 100 fastest growing companies developed their ideas through their former employment—either by recognizing an opportunity that the former employer didn't appreciate or even know about, or by improving upon some aspect of the company's products or services.”

Overall, the existing corporate infrastructure and antiquated operating methods are poorly designed to deal with today's climate. In this fiercely competitive world just providing a job doesn't do nearly enough to promote innovation—the ultimate goal for progressive companies. What is needed is an Innovation Management System.

Existing Technology in the Knowledge Management Field

The Knowledge Management industry is quickly consuming the myriad fragmented and disparate niche industries that have evolved over the past two decades, including document management, search and retrieval, repositories, object technology, workflow, and most recently the intranet. According to Delphi Consulting Group, buying trends for IT will revolve around this central theme for the next decade.

The most significant aspect of this industry is the growing awareness of the increasing amount of useless data—in other words, no information—in a typical company. Strategically, companies are realizing that knowledge is the key driving force in the next decade, and systems which help manage documents, search, and aid collaboration are desperately needed. In a recent survey, nearly half (43%) of the survey population regarded knowledge management as an opportunity to add value to information inside and outside the organization. But nearly as many respondents (37%) viewed knowledge management in a very different light_as a “major new strategic initiative for staying competitive.” Overall, 80% view knowledge management as providing an important contribution to business practice, and 46% of that group views knowledge management as strategic. This same group was asked the primary repositories of corporate knowledge and the biggest obstacles to creating knowledge-based organizations; the results are shown in the charts in FIG. 1.

The data however clearly show that while employees are the primary sources of information in the company, all of the current solutions have focused on the remaining items: paper documents, electronic documents, and databases.

The data also reveals that the biggest obstacle is culture. The current business climate simply does not address the needs and wants of the typical knowledge “gold-collar” worker. These employees typically don't trust the “system.” Highly skilled workers know they can leave the corporate environment and get better returns, higher salaries, stock options, and greater opportunities than by simply handing over important innovations. Employees are even heard to say “why should I give ABC company my ideas, I'm going to start my own company.”

Accounting and valuation begin with documentation. A company with an expensive piece of capital equipment is sure to be aware of it. But most companies have valuable intellectual capital that they do not fully recognize. Many technology companies, for example, with dozens, hundreds or thousands of patents do not have a coherent catalogue of their patents, let alone an analysis of how their patents might be useful and how they might be exploited for economic and competitive gain.

These trends don't just apply to a limited number of high technology companies. Even companies not directly involved in high tech must realize that a substantial portion of their overall assets relate to intellectual property or capital. For instance, a small manufacturer may possess unique mechanical know-how, process knowledge, or techniques that create competitive space. Service companies use proprietary calculations and customer lists to their advantage. The implications of managing IP reach just about every industry classification and category.

The following needs can be identified among companies that produce IP. They need to organize intellectual property so that it can be quickly retrieved, filtered, and sorted by multiple criteria; they need to create an environment conducive to innovation by inspiring IP creation, sharing IP across the corporation, and promoting the intellectual output of individuals within the firm; they need to increase the value of corporate IP assets; they need to slow employee turnover and keep key employees from moving outside the company to start new enterprises; they need to communicate to employees, joint venture partners, and others that it is serious about protecting it's IP, and want to be sure that these same people have acknowledged this; and they need efficient and centralized access to disparate IP-related information, such as legal contracts, signed documents, IP, and usage patterns for making decisions about departing personnel, potential patent infringement, or partnership negotiations.

A brief look at the trade secret laws in the context of a buyer of IP assets provides further illustration of the need for an Innvation Management System. Today, there is no effective way for companies to accomplish this level of analysis, cost-effectively and efficiently.

Previous Attempts to Meet Customer Needs

Patent/IP Software

This category focuses on IP products. In general, the products are complex, patent-centric databases that best serve companies with large and extensive patent and trademark portfolios, and who are very serious about the strategic management of their patents. Many of the systems also include other software modules such as PTO filing, law case management, docket generation, and billing. They either target corporations, law firms, or patent practitioners. This niche has been fairly small, so most companies range in size from 60 to about 250 employees and have deployed in the neighborhood of 100's of customers. Prices range from $5,000 to $30,000 not including customization or installation. Examples in this category include Aurigin's IP Asset Management System, Computer Package's Patent and Trademark Management System, Master Data Center's PC Master, Maxim Technology's InProma, and OP Solution's PATTSY.

ERP/Knowledge Management Software

Almost every software company in existence today can claim some share of the Knowledge Management marketplace. This category of competitors is so numerous it's difficult to find any clear distinguishing differences between them. Most of the products are “enhanced” tools such as database searching, document management, groupware, and personal web page publishing. A recent KM publication listed 36 different software groups as part of the KM marketplace, including Application Development Products, Business & Competitive Intelligence, CAD, CD-related technologies, Collaborative & Work Management, Compound Document Management Software, Data Mining, Data Warehousing, Database Management Systems, Document Conferencing, Document Design/Publishing, Document Management Software, DVD-related technologies, Electronic Commerce, Engineering Document Management Systems, ERP Systems, Forms Processing, Groupware, Image Compression, Image Manipulation, Image Processing, Imaging Application Systems, Input Capture Systems, Intellectual Asset Management, Internet/Intranet Development, Knowledge Management Software/Tools, Micrographics, Multimedia Systems Software, Networking Systems Software, OCR/ICR/OMR Barcoding, On-Demand Print Systems, Portable Document Viewing, Records Retention/Archiving, Storage Management Systems, Text Retrieval & Management Software, and Workflow.

Clearly, this list contains everything imaginable related to documents and is a highly fragmented conglomeration of companies.

Knowledge Management Consulting

Since this is a complex concept to understand, it is a sure bet that every consulting firm that can claim any relevant expertise is involved. Arthur Andersen seems to be leading the pack in this area by performing IP audits, analyzing workflow processes, and then installing document management and groupware solutions. Most of the consulting firms are focusing on a holistic, and we believe overly broad, approach by examining all aspects of the organization's knowledge base: systems, processes, departments, and technologies. Their angle is that by correctly leveraging knowledge, a company can improve productivity, customer service, quality, speed to market, and other performance improvements. By helping organizations improve how they create, capture, share and apply the knowledge that exists within the company, they can more fully capitalize on it. Web-Based solutions

At present this category only contains one competitor, yet2.com. It appears to be focused on using the Internet as a business-to-business tool targeted at the license of IP for large corporations. Yet2.com has moved quickly to create associations with several premier companies, although the details of these relationships are unknown at this time.

### DISCLOSURE OF THE INVENTION

A three-tiered, scalable, web-based architecture (“the system”) is disclosed to dynamically and cost-effectively promote innovation, foster learning, encourage preservation, and allow the management and maximization of corporate IP assets; a solution for automating and managing the modern-day enterprise IP environment. This system works efficiently within the legal parameters of any company environment, regardless of industry, and works in cooperation with In-house Counsel. With real-time access to key information, IP Counsel can focus on higher level, strategic issues, and not mundane documentation tasks.

A reliable, real-time system for creating, preserving and building value from corporate IP assets is disclosed. The system is in synch with today's digital world and enterprise environment and operates on a continuous, real time basis. It works transparently with the way in which employees work and innovate, it is a useful productivity tool for IP attorneys and corporate counselors, and it safeguards and protects the most valuable assets a company owns, its intellectual capital. It uses the potential of information technology to streamline processes, promote new innovation, and document and protect a company's assets. It does a very effective job of providing the Knowledge-connectivity™ and incentive for new innovations.

The system meets all of the needs identified above. Using the system, companies can organize intellectual property so that it can be quickly retrieved, filtered, and sorted by multiple criteria; create an environment conducive to innovation by inspiring IP creation, sharing IP across the corporation, and promoting the intellectual output of individuals within the firm; increase the value of corporate IP assets; slow employee turnover and motivate key employees from moving outside the company to start new enterprises; communicate to employees, joint venture partners, and others that they are serious about protecting their IP, with assurance that these same people have acknowledged this serious view; and achieve efficient and centralized access to disparate IP-related information, such as legal contracts, signed documents, IP, and usage patterns for making decisions about departing personnel, potential patent infringement, or partnership negotiations. With the system companies can accomplish a cost effective and efficient level of analysis as to their trade secrets or any other IP assets.

The System also delivers three key benefits: Value Creation, Awareness, and Accountability.

Value Creation

One of the goals of the system is to inspire and promote new innovation within corporations. We don't believe that the innovation process is optimized for either companies or employees. Our systems help to foster an environment where creativity is recognized and rewarded in direct alignment with the goals of the company. A company that recognizes the contributions of its employees will certainly create a more stable employment environment—and attract talented people—sharpen its competitive edge, and ultimately become more successful. The system employs system-level tools that inspire the creation and sharing of new ideas and knowledge, which ultimately contributes to the increased valuation of any company.

Awareness

By making employees more aware and sensitive to the treatment of proprietary information, companies will be better protected from the risk of detrimental loss. Most employers do not realize that the two greatest risks to IP are employees stealing secrets or divulging secrets at a future job. Employees need to recognize the significance of a company's IP assets and understand their responsibility for preserving them. Even a single unprotected disclosure can mean the permanent loss of a valuable trade secret. The system increases the threshold of awareness in a company's working environment, and at the same time demonstrates the company's proactive concern for safeguarding its valuable assets.

Accountability

Among all the assets that a business owns, its IP may be the most important and valuable. To substantiate this, the Brookings Institution in Washington surveyed U.S. manufacturers in 1982 and determined that physical assets such as factories, property, and equipment made up 62% of the companies' total market value, with the rest of the value represented by proprietary knowledge. Ten years later, the researchers determined that physical assets accounted for only 38%, with the remainder consisting of the firms' intangible knowledge assets.

Xerox actually invented the Windows concept of computer software perhaps two decades ago, long before Apple and Microsoft locked in their currently well-known legal dispute. But for all of its size and resources, Xerox failed to seek a patent and never gained a foothold in the market Apple eventually dominated.

A sustainable competitive advantage depends on how effectively a company can manage, protect and exploit IP—corporate survival depends on it. The last thing that a company needs is for lax oversight to put these assets at risk. Corporate leaders have a baseline responsibility to preserve corporate assets and work to capitalize on them. The System provides the information that a company needs to ensure that it is responsibly doing its very best to preserve assets, answering such questions as, “What specific trade secrets exist in the business today? Are they being properly and consistently maintained? Who has direct access to them?”

User/System Benefits

The table below highlights departments and individuals within the typical corporate environment who will benefit from using the System. For each example, the user's needs and the ultimate system benefits are shown.

| Corporate Player | IP Needs | System Benefit |
|---|---|---|
| Marketing | Needs to be able to | The System automatically |
| | determine competitive | summarizes company innovations. |
| | strengths and weaknesses, | The System performs detailed |
| | new areas of market growth. | searches on the Internet to find |
| | | competing or encroaching ideas; |
| | | reports are available which list |
| | | potential competitive strengths or |
| | | weaknesses. These searches are |
| | | performed automatically and |
| | | routinely using intelligent agents, |
| | | giving market analysts a jump-start |
| | | on which areas to investigate. |
| Executive | Needs to get an accurate | Graphic presentations and detailed |
| Management | picture of the level of | reporting of the number of |
| | innovation in the company. | innovations per month, year, or |
| | Are employees building | quarter give senior managers a |
| | corporate value? Are we | firm understanding of their level of |
| | recognizing our key | innovation. Further stratification of |
| | contributors? | the data by department or job |
| | | function can help develop future |
| | | strategic direction. |
| | Are we properly protecting | Summary reports display access to |
| | and preserving our assets? | protected information by class, |
| | | type, date, user, etc. Management |
| | | can quickly assess the level of |
| | | protection, and if needed, can |
| | | globally change security levels to |
| | | reflect changing environments. |
| Tech Employee | Wants recognition for new | Innovation Management System ™ |
| | ideas and innovations | allows the user to “certify” the idea |
| | | with immediate supervisor, |
| | | corporate IP, and posting for |
| | | company-wide viewing on the |
| | | corporate intranet. |
| Corporate IP | Has to have a “handle” on | The system creates an instant |
| | the specific IP being | snapshot of the current state of all |
| | created-owns | IP in the company. Its like getting |
| | responsibility for oversight. | an instantaneous IP audit at the |
| | What is being created, what | touch of a button. |
| | is its value, who is creating | |
| | it, what means of protection | |
| | should be employed? | |
| Human Resources | Inform departing employees | By allowing instant access to the |
| | that they have an on-going | usage pattern for any individual |
| | obligation to keep corporate | who has viewed corporate secrets, |
| | trade secrets and | HR can quickly generate and show |
| | intellectual property | departing employees a listing of all |
| | confidential. | confidential materials accessed |
| | | and printed. Furthermore, HR can |
| | | quickly print out scanned images of |
| | | the departing employee's signed |
| | | confidentiality agreements, non- |
| | | disclosure statements, and policy |
| | | acknowledgements. |
| Human Resources | Provide more meaningful | In addition to all of the usual |
| | data to the employee review | employee review data, HR can |
| | process | query the System and determine |
| | | all of the ideas that an individual |
| | | has submitted over the past year. |
| | | How can you measure the |
| | | productivity of a “business |
| | | development manager” without it? |
| Finance | What is the value of the | Because idea submitters enter |
| | company's goodwill? Needs | hours spent, along with other |
| | to try to determine the costs | resources that contributed to the |
| | of a new product launch, the | innovation, assets can be assigned |
| | total corporate value of IP or | tangible values and tracked on the |
| | trade secrets. | company's balance sheet. |

The System streamlines the process of creating, preserving and protecting proprietary assets. The System identifies, classifies, compiles, tracks and routes real-time data automatically on a continuous basis. It provides instant access to stored database information, such as trade secret archives, patent filings, computed valuations, user information and a variety of detailed reports. A client has instant access to their latest innovations and proprietary materials, and constant supervision over them. They know precisely the status of their property, and can quickly view summary reports and valuation data. This information is extremely beneficial in linking IP to the company's strategic objectives. See FIG. 2.

The System is highly configurable and creates a wide range of user-selectable classifications of assets, allowing the system to be customized in alignment with individual business needs. For example, a software development company can selectively designate individual network folders as “CLASS 1” Trade Secrets. A number of parameters can be associated with this CLASS 1 status or mode. In this scenario, CLASS 1 provides the ultimate level of protection. Every access to these trade secrets will be monitored and logged by the System. If necessary, and depending on the protective features enabled, every user action such as viewing, printing, copying, and modifying can be transparently logged and sent to the main Server. See FIG. 5.

You instantly know who has accessed your key IP files, and who has downloaded them, viewed or copied them. This level of data acquisition can be invaluable in the case of employee ownership disputes, determining level of disclosure, or commercial licensing negotiations. And even more importantly, all of this data is essential to proving that your company took the necessary preventative precautions to protect the secrecy of your trade secrets—invaluable in the face of future litigation.

Innovation Management System

As stated earlier, the existing corporate infrastructure and antiquated operating methods are poorly designed to deal with today's climate. The Innovation Management System™ is needed.

An Innovation Management System (IMS) is disclosed. This preferably web-based GUI encourages innovation, providing valuable benefits to both employees and employers. It allows employees to enter their intellectual creations (documents, ideas, schematics, etc.) and receive an immediate, time/date certification. In many instances, one of the greatest reservations employees have against providing ideas to upper management or other departments is the lack of control, authorship, and credit they associate with typical corporate environments. At one time or another, we have all been victims of intellectual theft—perhaps a design sketch given to your boss concerning a product improvement that appears months later in a corporate document without your name on it. In addition to certification and registration, the system can provide automatic e-mail notifications to an immediate supervisor and the corporate IP department (all configurable), as well as entry and logging into the company-wide recognition database. Others in your company, with appropriate privilege levels, can search (by key words, project descriptions, PTO classifications, author, date, etc.) and instantly access archived innovations, increasing the level of inter-company collaboration. The company can create more effective incentives and “innovation awards” tightly coupled to strategic goals.

Users of the IMS can link to more details on each submission, email comments and suggestions directly to the author (for improved collaboration and knowledge management), or even submit their own improvements as a new or supplemental innovation. See FIG. 13.

The IMS database becomes an efficient tool for HR departments, and can be used for evaluating employee performance, measuring overall corporate innovation levels, and identifying qualified and motivated employees to join a special R&D team.

The Corporate Legal Department will benefit because the IMS provides extensive documentation in a wide-range of beneficial areas. For instance, IP Counsel can monitor for new patentable ideas in real time, since they are directly linked into the system. This efficiency can reduce the time necessary to prepare and prosecute new patents. It also frees up Patent Attorneys to higher-level activities, instead of mundane data collection work. The IMS will enable attorneys to provide improved oversight for new trade secrets before they are lost through inadvertent disclosure. The system archives the documentation trail from the outset, invaluable for assignment issues and establishing firm priority dates. IMS Web Site

The IMS also provides an interface to the external Internet (optional and configurable). Ideas and submissions can be published and linked to an external (i.e. MindMatters.com) web site. The site serves as an innovation access link to companies all over the world. It is possible for interested buyers and sellers to initiate exploratory communications via embedded links, as well as conduct negotiations on available licensable technologies. There is an appropriate legal framework to streamline the exchange of information for the site, assuming that at a certain level, the materials may contain proprietary information.

The site also provides an optimum way for companies to initially view “unsolicited ideas” without the threat of legal reprisal or the burden of lengthy, internal approval processes. Today, many companies are extremely cautious about looking at unsolicited ideas, even potentially valuable ones, because of the potential threat of future litigation. There have been a multitude of cases in recent years involving the purported misappropriation of inventions and ideas resulting from even casual discussions. In response, many companies have established cumbersome, paper-intensive procedures to deal with unsolicited ideas. Some have prohibited them altogether. Needless to say, this constricts the flow of innovation. The site solves this problem as well by building in a protective legal barrier and managing the information exchange. The site acts as a safe and efficient conduit between the parties.

The IMS identifies innovations by key words, categories, PTO Classifications, dates, industries (SIC Codes), and identification/tracking numbers. Interested parties search the web site for innovations applicable to their own businesses or use “search agents” which automatically notify them if something meets their criteria. If they find ideas that merit further investigation, clicking on an e-mail link automatically connects them to the author or representative. By aggregating innovations at the web site, we are actively promoting innovation and knowledge sharing on a broader scale, while simultaneously building a meaningful intellectual property resource. This site becomes the first link in establishing meaningful relationships for future licensing and royalty agreements. See FIG. 3.

A nominal fee is charged for creating the direct link between subscribers and new ideas. When a subscriber chooses to contact the source of the innovation, i.e., by email, a different small fee will be charged. This fee may be negligible in the early stages, in an attempt to drive usage and minimize nuisance requests (such as $0.33). A membership subscription is also contemplated. Other interaction, including submitting ideas, searching for ideas, or configuring “search agents” are free of charge.

Simple Installation

Today's MIS manager has less time than ever to fiddle with finicky programs or configure endless mazes of menus. The system is designed to plug quickly into the network and instantly begin collecting information in its basic configuration. The system simply needs to have an IP (xxx.xxx.xxx.xxx Internet Protocol) address for the network, and a physical connection to the network. IT managers can remotely configure the system via a web interface, and independent systems can be hierarchically managed, along with reporting, back to a central monitor. Communication takes places in encrypted channels. Installation of web components is even simpler as the applications/date are easily installed into an existing web server.

The system is a scalable, modular system that can be implemented incrementally over time. Network solutions are implemented and designed around standard Microsoft DNA components.

Improvements over Existing Knowledge Management Technology

An important benchmark industry to compare disclosed products and services with is the field of Knowledge Management. As stated above, there is growing awareness of the increasing amount of useless data—in otherwords, no information—in a typical company.

Increasing the value of corporate information is important; however, rather than just designing tools to plod through piles of data, the system is an accounting framework that values (using legal standards as a model), helps protect, and most importantly creates information. But where the Knowledge Management industry has focused on only paper documents, electronic documents, and databases, not employees. The system focuses on all four elements, realizing that employees are the most critical, through the Innovation Management System (IMS). IMS makes itself the employee's “best friend,” as this is the key starting point in the innovation process. If employees trust and use the IMS to help them accomplish their personal goals (while simultaneously satisfying the corporate goals), then the flow of new innovations will be substantial.

The data also reveals that the biggest obstacle is culture. The system addresses the needs and wants of the typical knowledge “gold-collar” worker. The IMS overcomes the cultural disinclination of such workers by allowing innovators to share in the glory and financial success of their ideas. The System will also set the bar for what is required for companies to prove that they did in fact take reasonable measures to protect their assets.

The system is designed to provide an appropriate interface to previous systems that attempt to meet customer needs, such as patent/IP software, and knowledge management software.

The disclosed system is a comprehensive, supervisory system that functions seamlessly on top of existing architectures, and which efficiently monitors and promotes innovation. Innovation is the core focus. The system is unique in that it is designed from the bottom up to be extremely easy to install and integrate with existing systems. Administrators will be able to install it incrementally in a modular fashion, as the needs and demands of the system grow over time. IP and Innovation managers will be able to progressively configure the system for customized applications, producing additional revenue streams from added licenses and services.

The disclosed system is superior to existing knowledge management consulting approaches, with or without Web enablement, at least in the critical area of IP tracking and management. The innovation content that a company provides under the disclosed system offers a much more compelling site to its users, both company users and the internet population. For example the system includes not only a web-trading interface, but also a mechanism for capturing innovation directly from the sources, transferring it through the organization, and protecting it from inadvertent loss. One of the key factors for success will be making it easy for participants in the web experience to upload information on a continuous basis. This keeps the information fresh and frees corporations from the laborious task of entering data repeatedly.

### BRIEF DESCRIPTION OF THE DRAWINGS

FIG. 1 is a set of charts showing corporate predilections for (a) repositories of data and (b) obstacles to creation of a fully function IP system.

FIG. 2 is a schematic diagram of a trade secret monitoring aspect of the system.

FIG. 3 is a schematic diagram of an Internet innovation marketing aspect of the system.

FIGS. 4a-d is set of screen shots showing an Explorer aspect of the IMS VB GUI, with a-c showing an earlier version and details on a system trade secret search, and with d showing a corresponding but updated Web version of a File Cabinet search page.

FIGS. 5a-b is a set of screen shots showing a Classes/Users aspect of the IMS VB GUI, with a showing an earlier version and with b showing a corresponding but updated Web version of a Human Resource search page.

FIG. 6 is a screen shot showing a Data Analysis aspect of the IMS VB GUI.

FIGS. 7a-c is a set of screen shots showing a innovation database Search Results aspect of the IMS VB GUI, with a showing an earlier version and with b-c showing corresponding but updated Web versions of a Database Search page and a NDA Tracker page.

FIGS. 8a-b is a set of screen shots showing a Monitor aspect of the IMS VB GUI, with a showing an earlier version and with b showing corresponding but updated Web version of an alternate search results page.

FIGS. 9a-b is a set of screen shots showing an Innovator Home Page aspect of the IMS Web GUI, with a showing an earlier version and with b showing an updated version.

FIGS. 10a-b is a set of screen shots showing an Innovator Submissions Page aspect of the IMS Web GUI, with a showing an earlier version and with b showing an updated version.

FIGS. 11a-b is a set of screen shots showing an Innovator Search Results Page aspect of the IMS Web GUI, with a showing an earlier version and with b showing an updated version.

FIG. 12 is a screen shot showing an Innovator Corporate Page aspect of the IMS Web GUI.

FIG. 13 is a screen shot showing an Innovator Top Innovations Page aspect of the IMS Web GUI.

FIGS. 14a-b is a set of screen shots showing an Innovator Database Search Results Page aspect of the IMS Web GUI, with a showing an earlier version and with b showing an updated version.

FIGS. 15a-d is a set of screen shots showing an Innovator Management Tools aspect of the IMS Web GUI, with a showing an earlier version and with b-d showing updated versions.

FIGS. 16a-b is a set of screen shots showing an Innovator Summary Page aspect of the IMS Web GUI, with a showing an earlier version and with b showing an updated version.

FIGS. 17a-b is a set of screen shots showing an Innovator Details Page aspect of the IMS Web GUI, with a showing an earlier version and with b showing an updated version.

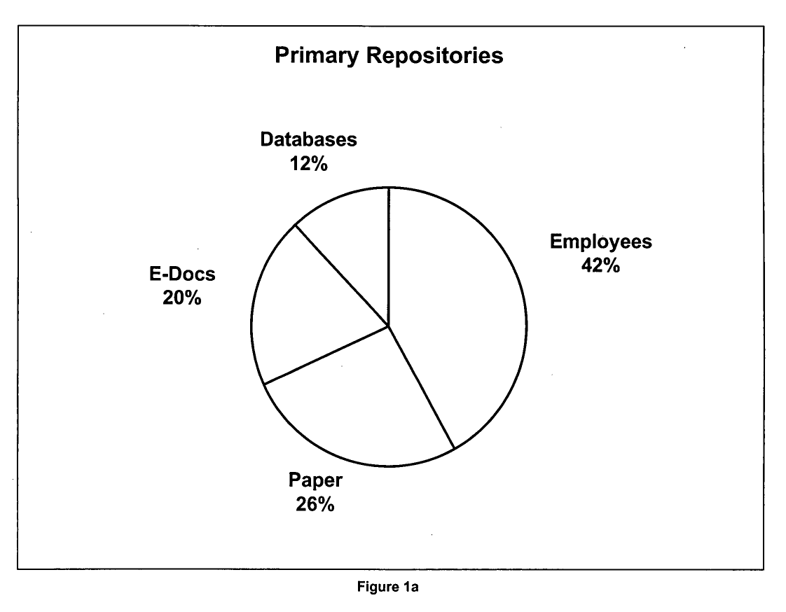

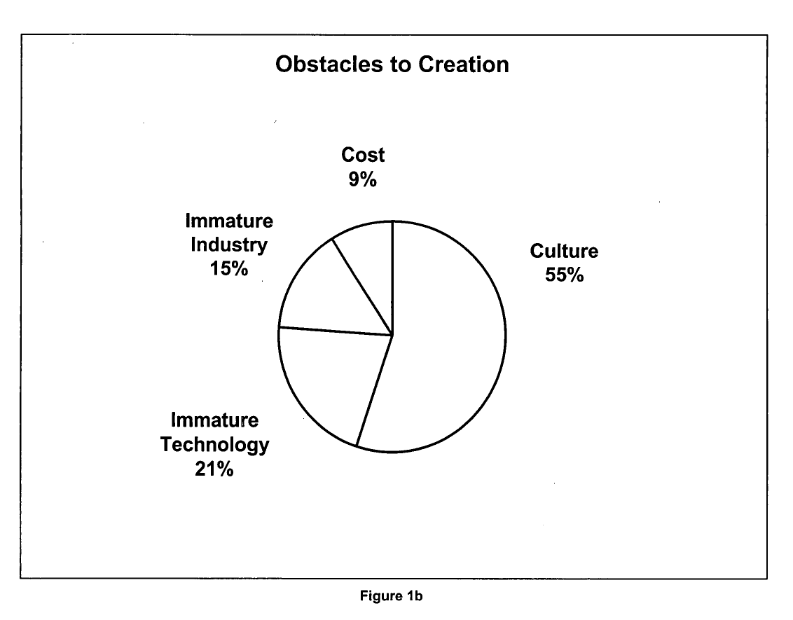

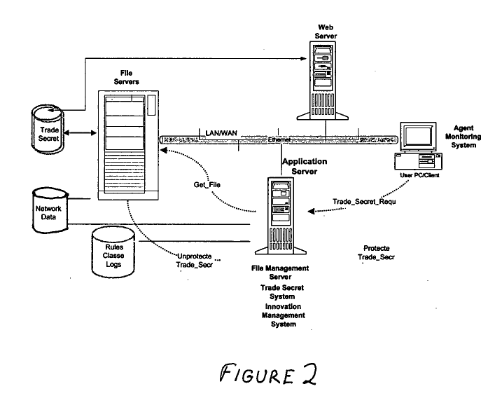

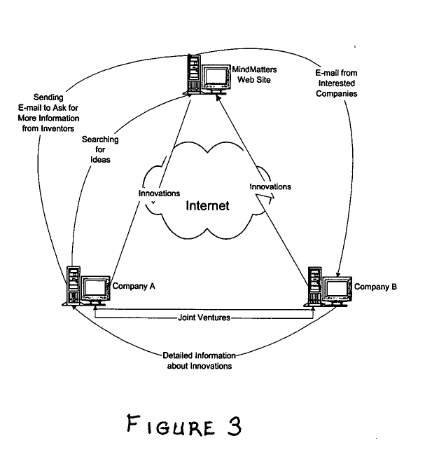

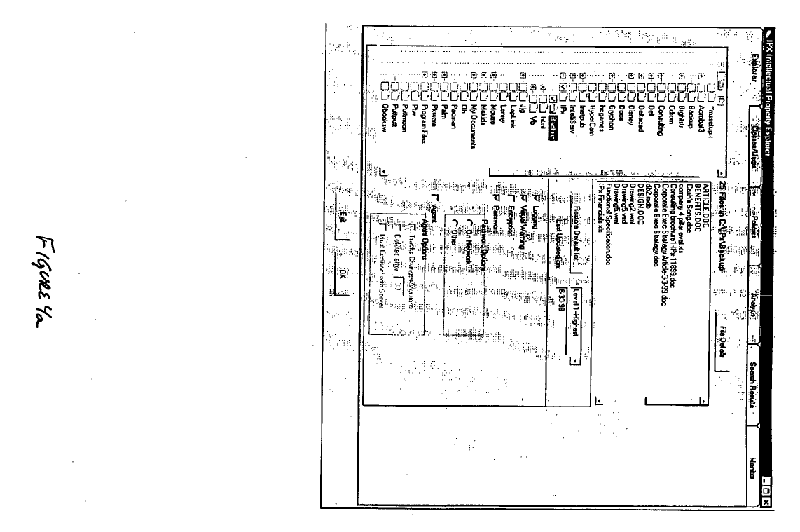

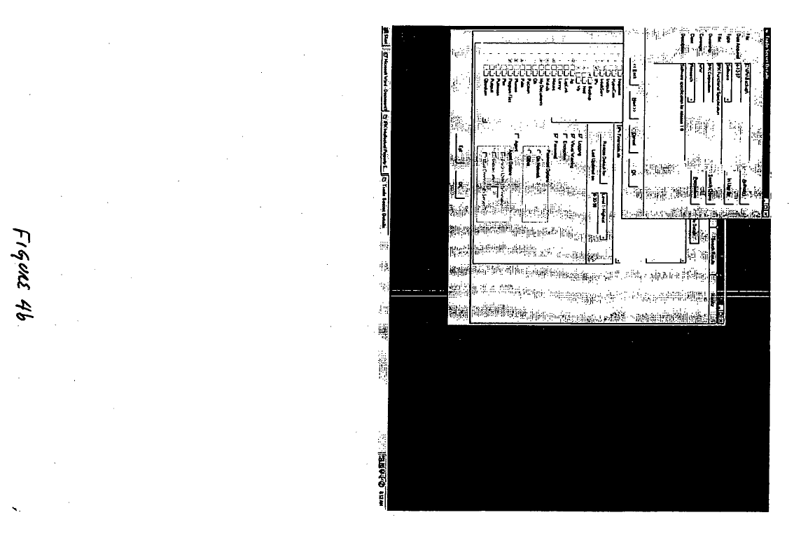

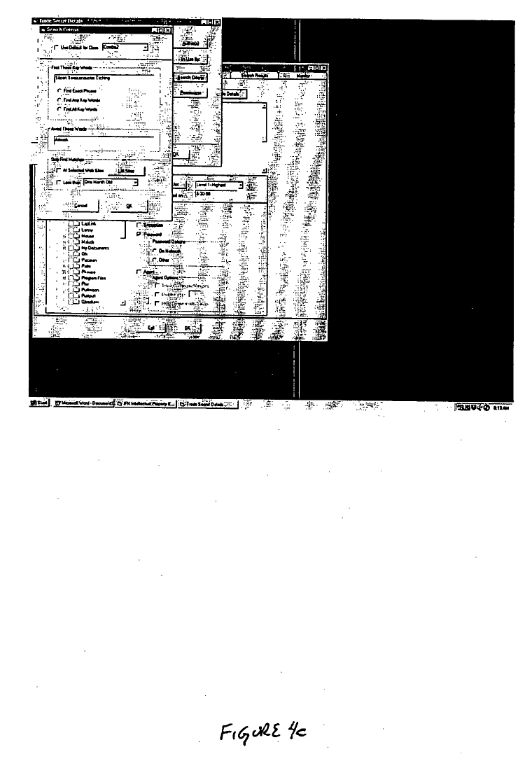

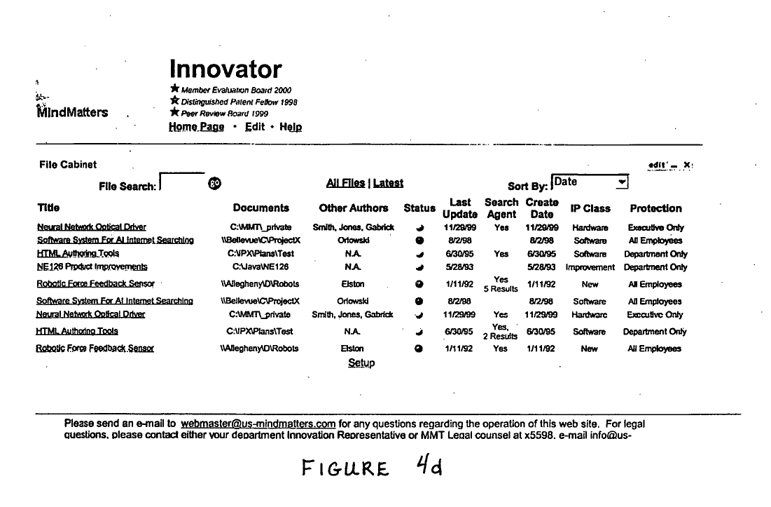

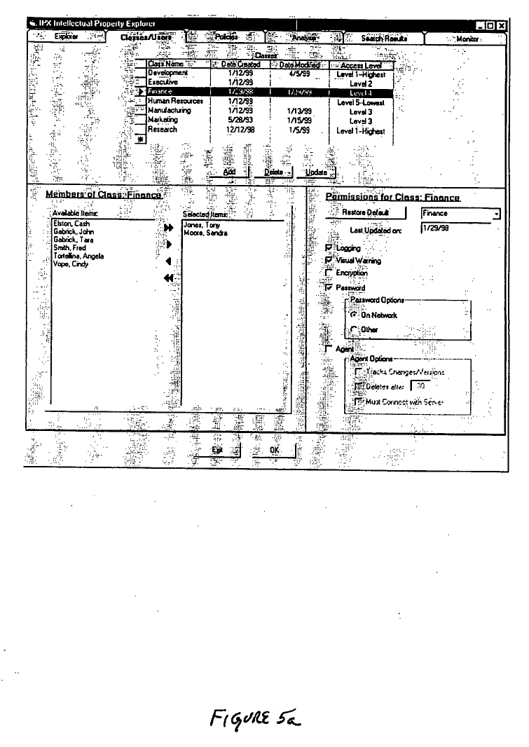

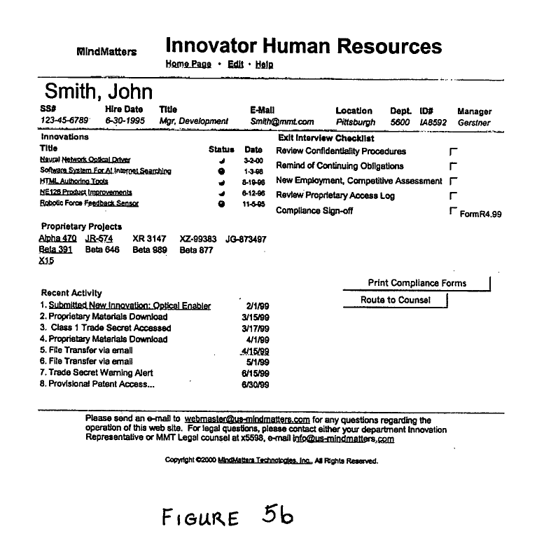

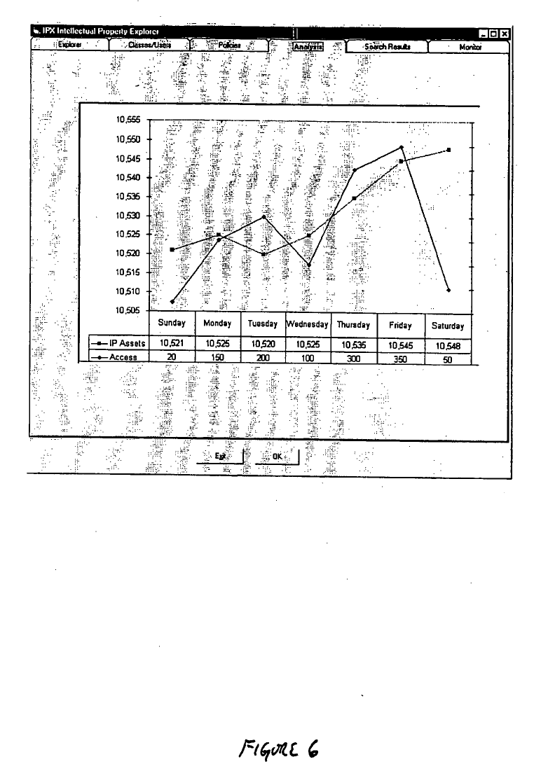

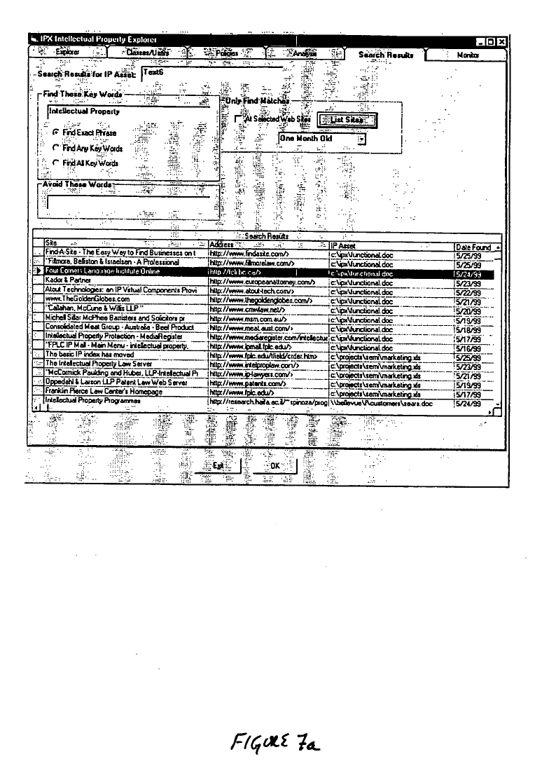

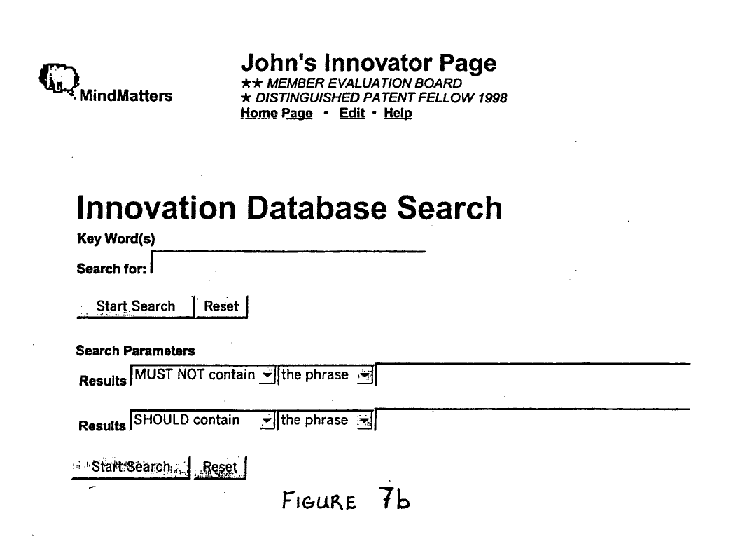

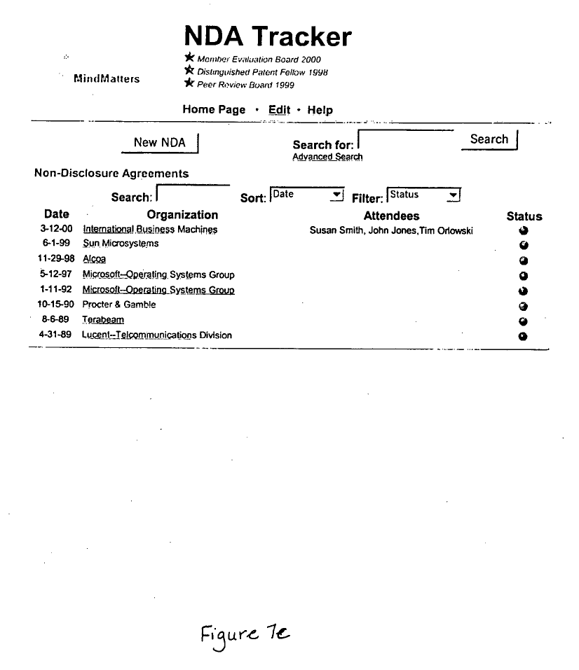

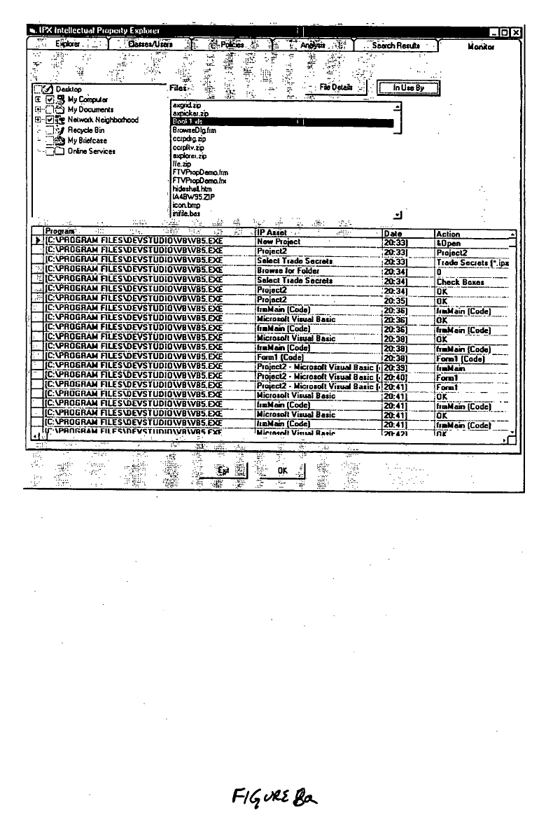

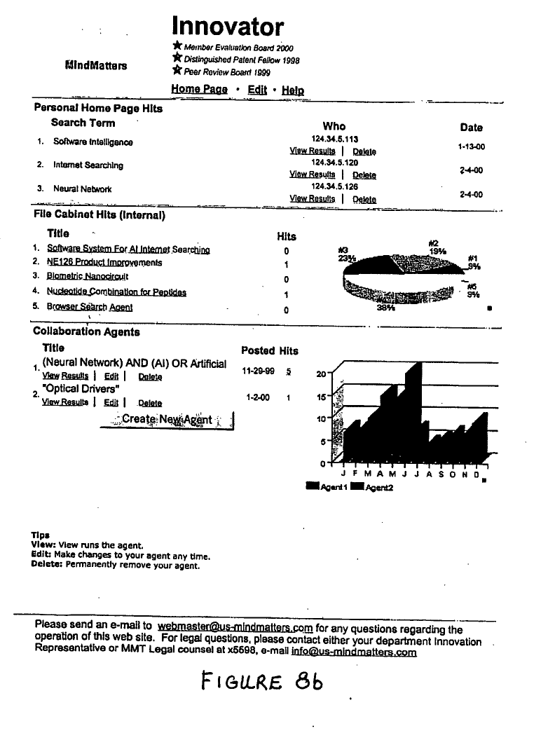

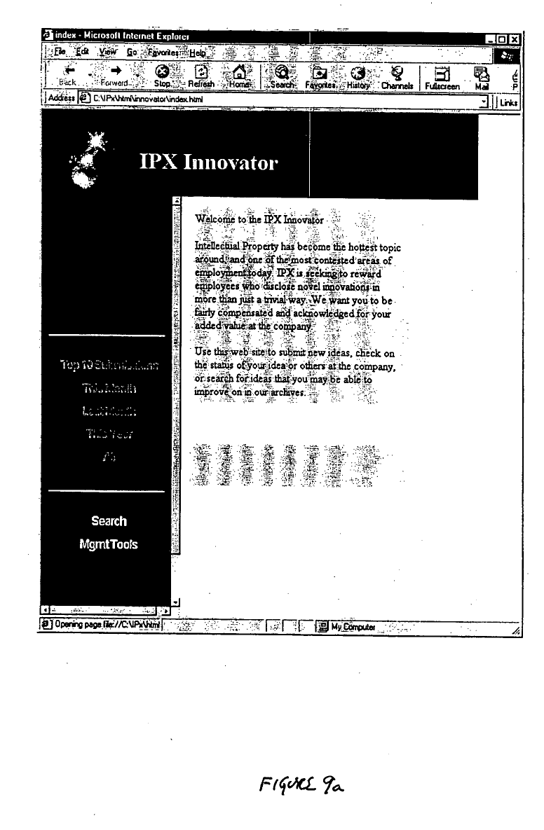

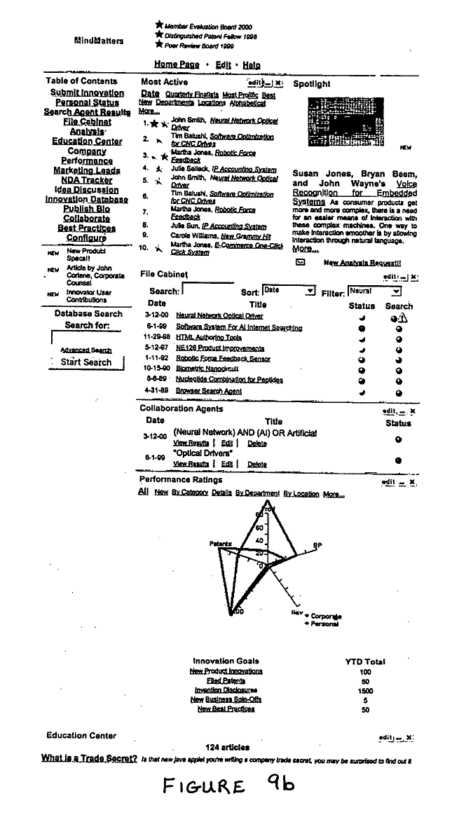

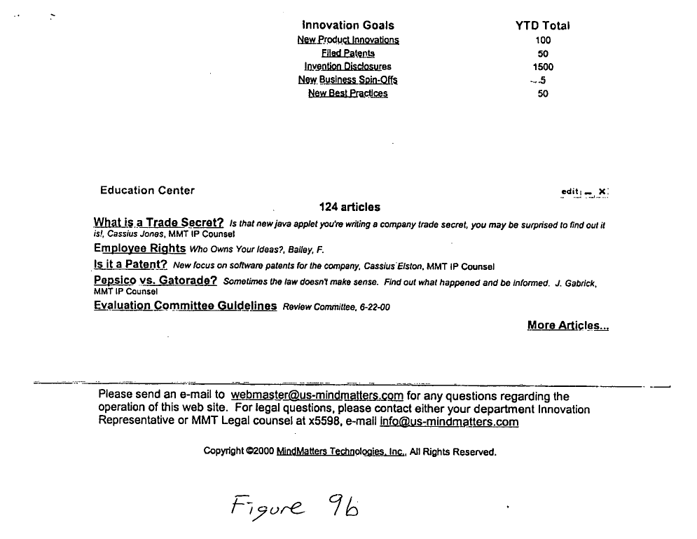

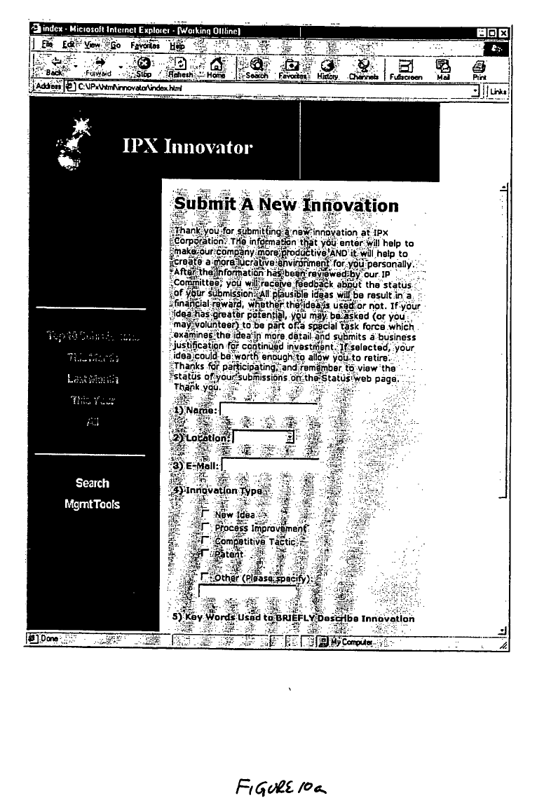

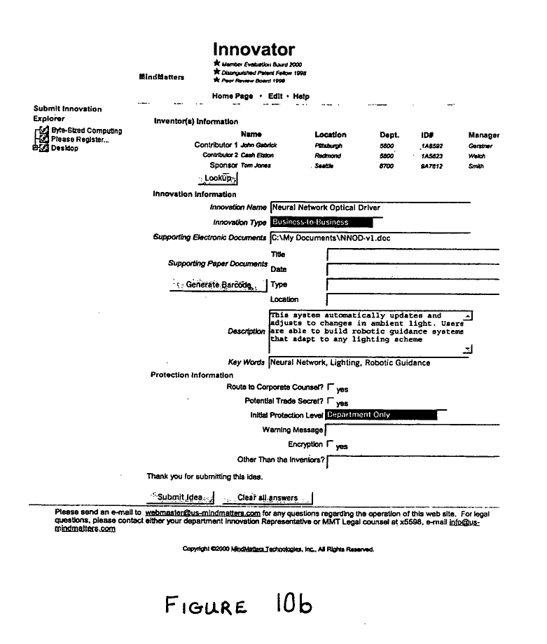

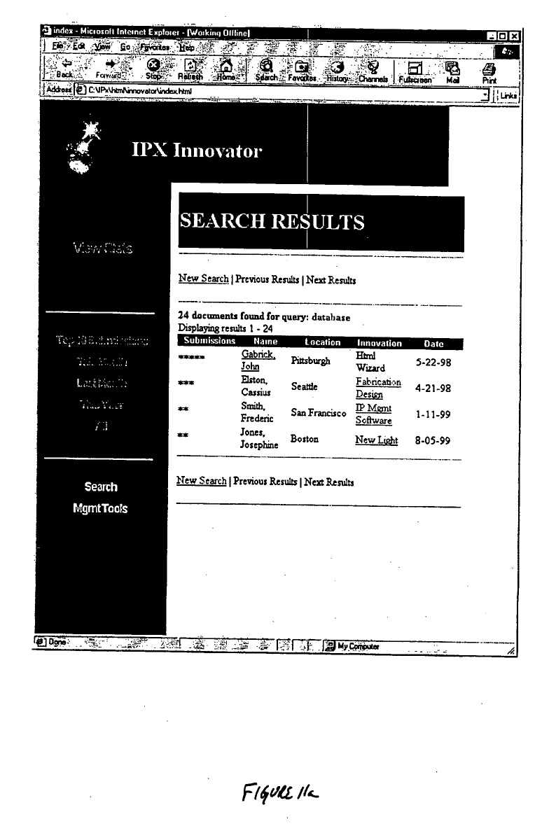

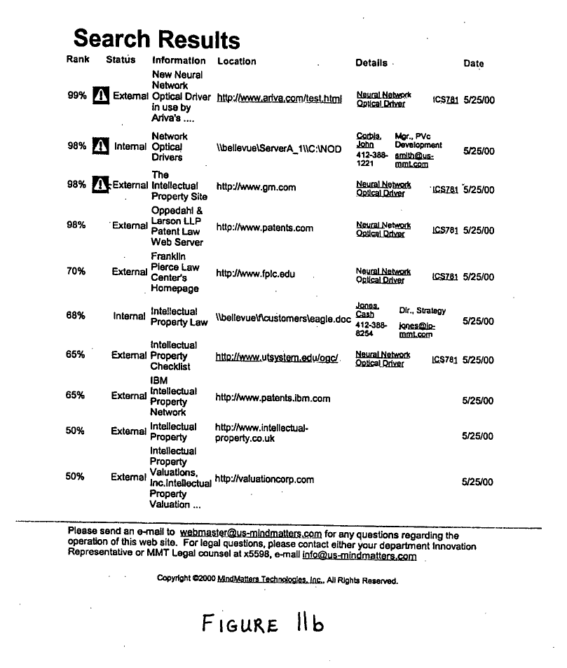

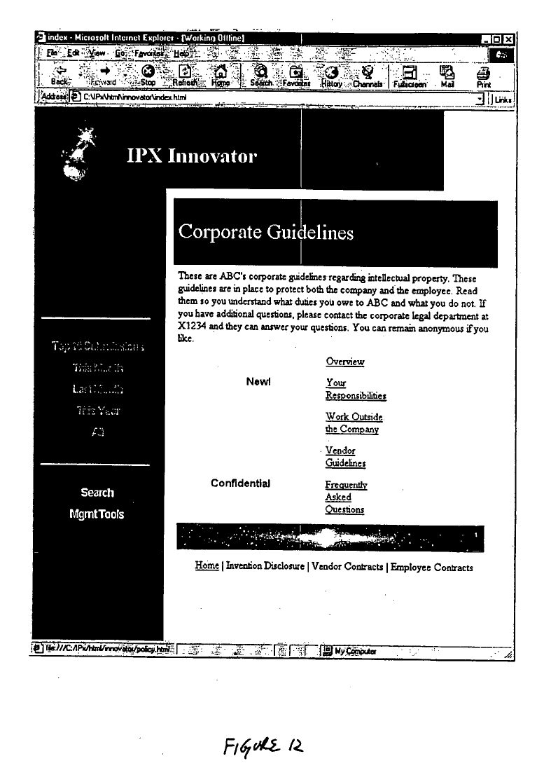

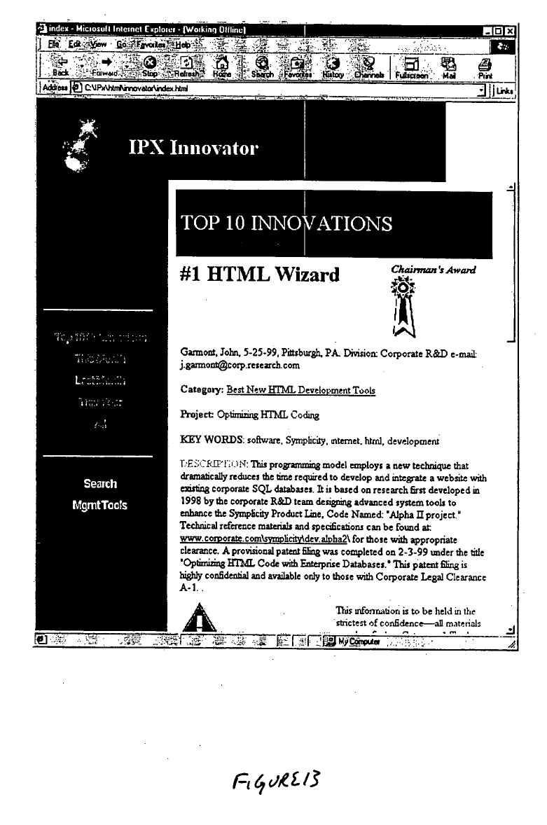

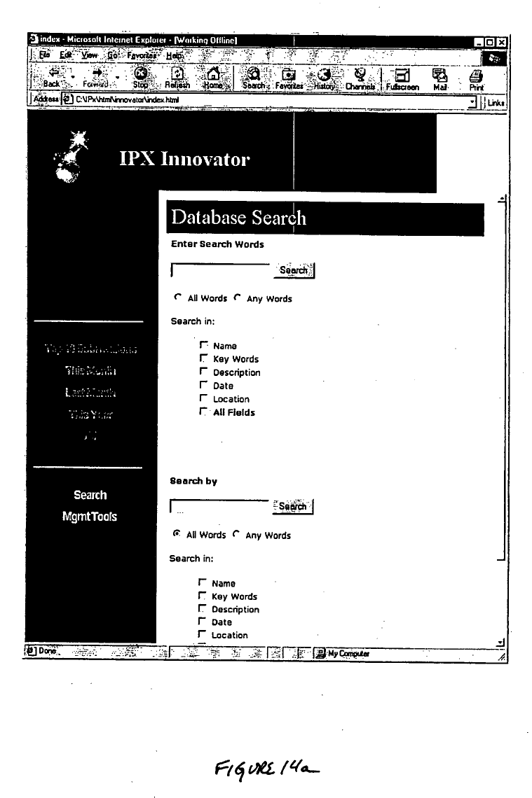

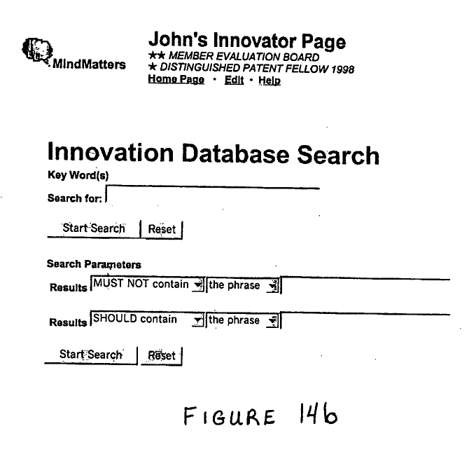

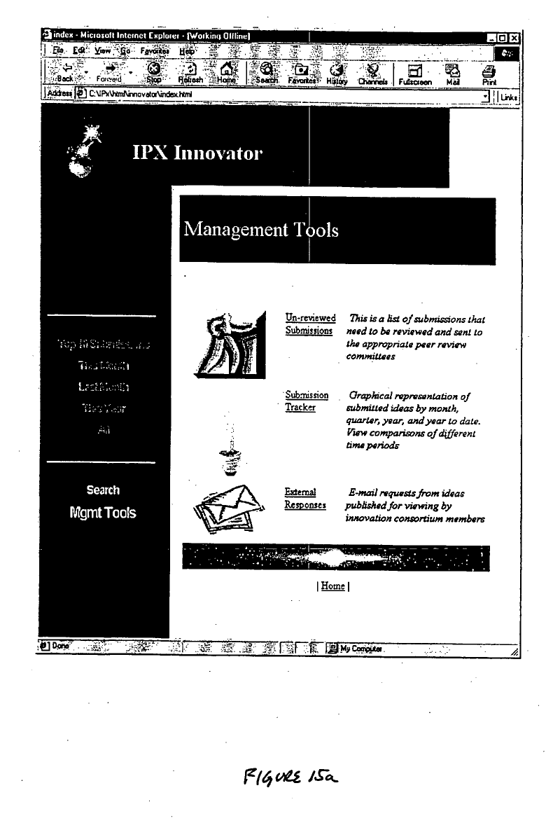

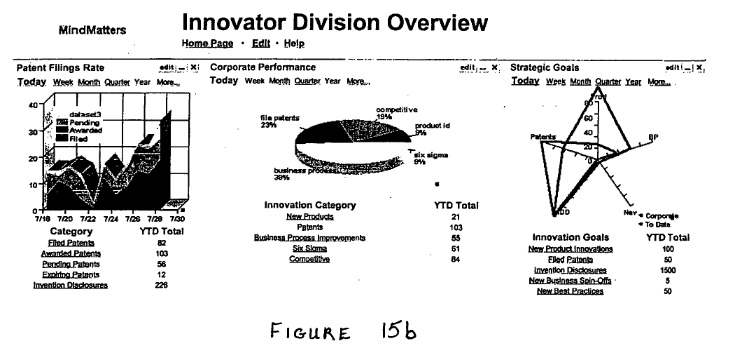

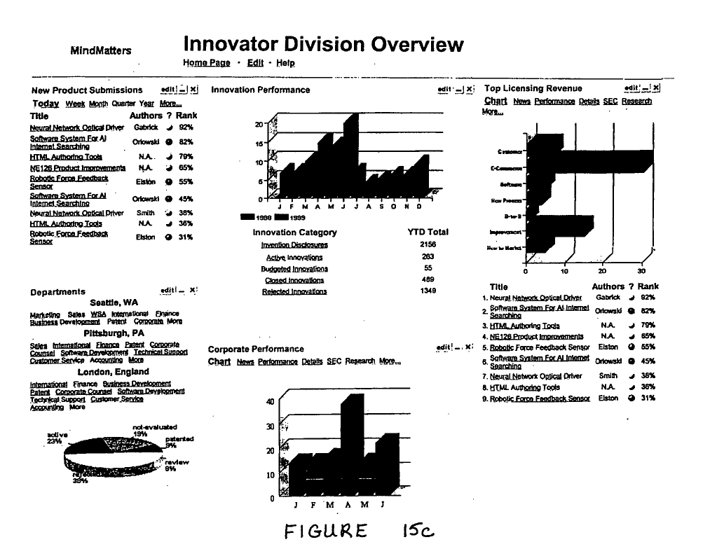

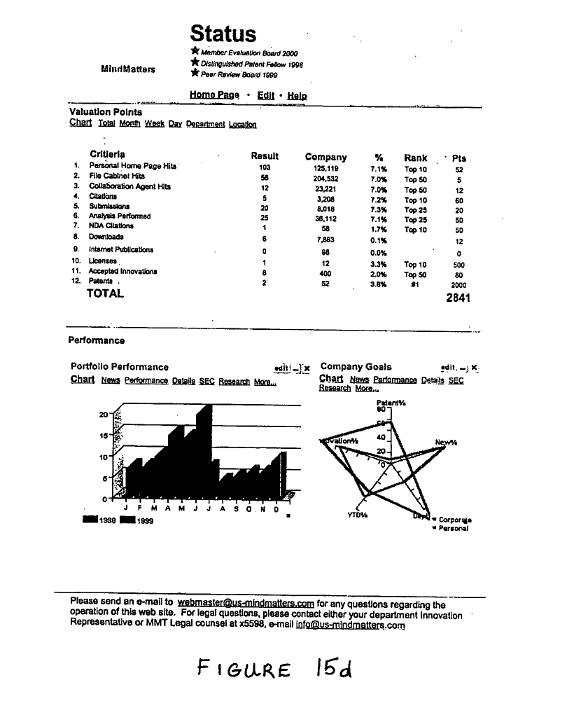

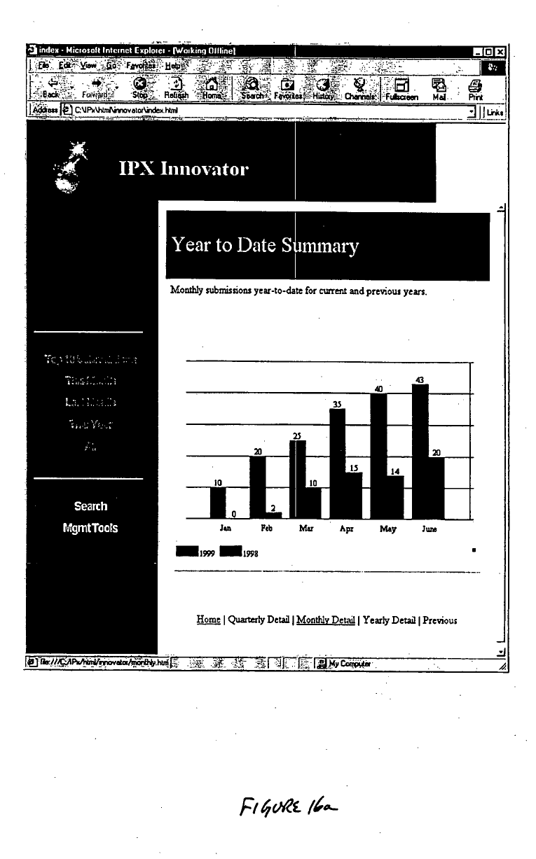

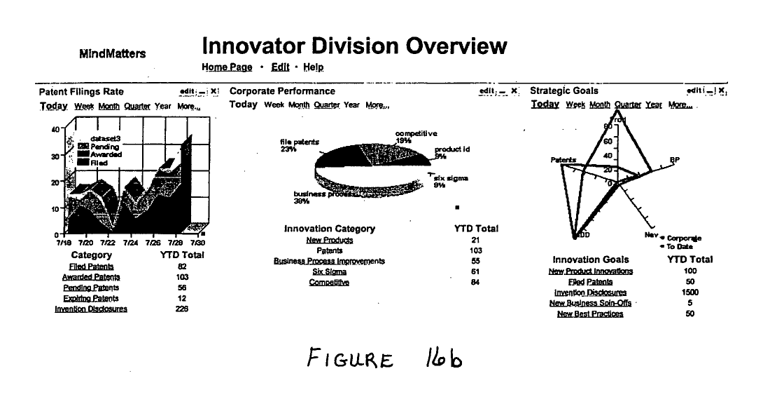

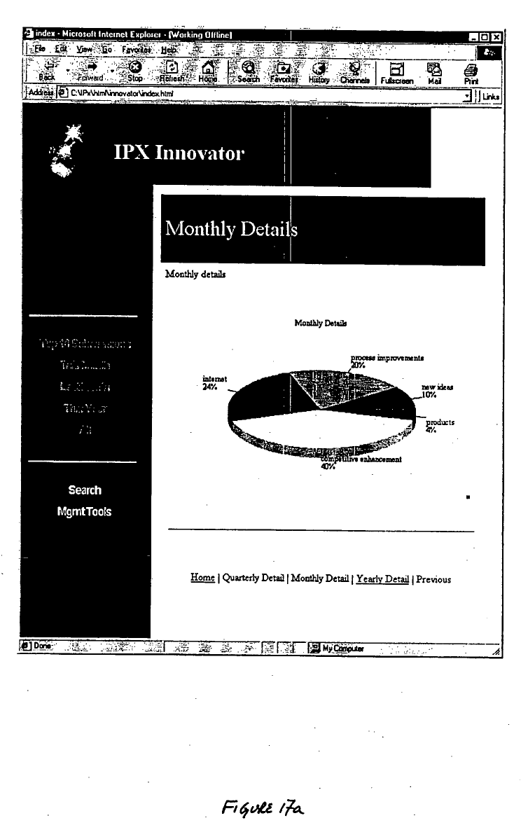

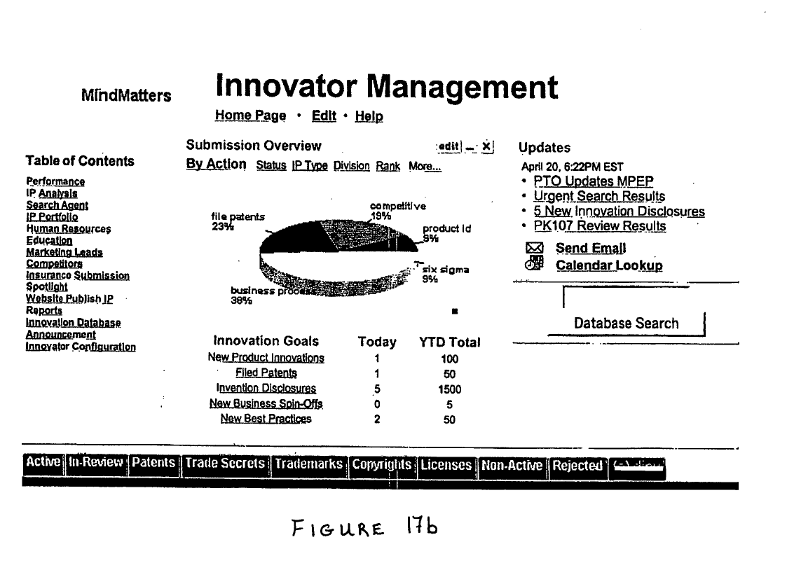

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

We claim:

1. An intellectual property management method, comprising:
entering information associated with an innovation;
storing the information and a date the information was stored in a database; and
receiving a certification including the information associated with the innovation and the date the information was stored in the database.

2. The intellectual property management method of claim 1, wherein the information associated with the innovation includes at least one of a document, an idea, and a schematic.

3. The intellectual property management method of claim 1, further comprising time stamping the certification.

4. The intellectual property management method of claim 1, wherein the information associated with the innovation is entered by a user.

5. The intellectual property management method of claim 4, further comprising notifying a second user the information associated with the innovation was entered.

6. The intellectual property management method of claim 5, wherein the second user is a supervisor of the user.

7. The intellectual property management method of claim 4, further comprising providing access to the database to other users.

8. The intellectual property management method of claim 7, further comprising another user providing to the user a comment related to the information associated with the innovation.

9. The intellectual property management method of claim 1, further comprising:
entering additional information associated with the innovation; and
accessing the information associated with the innovation and the additional information associated with the innovation simultaneously from the database.

10. The intellectual property management method of claim 1, wherein the database is an intellectual property database.

11. The intellectual property management method of claim 1, further comprising:
providing a plurality of entries of information associated with a plurality of innovations; and
measuring the plurality of entries.

12. The intellectual property management method of claim 11, further comprising identifying users entering the plurality of entries of information associated with the plurality of innovations.

13. The intellectual property management method of claim 1, further comprising monitoring the information related to the innovation in real time.

14. The intellectual property management method of claim 1, wherein the information related to the innovation includes a patentable invention.

15. The intellectual property management method of claim 1, wherein the information related to the innovation includes a trade secret.

16. The intellectual property management method of claim 1, further comprising archiving the information associated with the innovation.

17. The intellectual property management method of claim 16, further comprising protecting the innovation from inadvertent loss.

18. The intellectual property management method of claim 1, further comprising publishing the innovation on the Internet for consideration by at least one of buyers and sellers of licensable technology.

19. The intellectual property management method of claim 1, further comprising identifying the innovation by at least one of a key word, a category, a patent and trademark office classification, a date, an industry, a standard industrial classification code, an identification number, and a tracking number.

20. An intellectual property management method, comprising:
entering information associated with an innovation;
storing the information and a date the information was stored in a database;
entering additional information associated with the innovation;
storing the additional information and a date the additional information was stored in the database; and
linking the information associated with the innovation and the additional information associated with the innovation in the database.

21. The intellectual property management method of claim 20, wherein the information associated with the innovation includes at least one of a document, an idea, and a schematic.

22. The intellectual property management method of claim 20, further comprising receiving a certification including the information associated with the innovation and the date the information was stored in the database.

23. The intellectual property management method of claim 22, further comprising time stamping the certification.

24. The intellectual property management method of claim 20, wherein the information associated with the innovation is entered by a user.

25. The intellectual property management method of claim 24, further comprising notifying a second user the information associated with the innovation was entered.

26. The intellectual property management method of claim 24, further comprising providing access to the database to other users.

27. The intellectual property management method of claim 20, further comprising accessing the information associated with the innovation and the additional information associated with the innovation simultaneously from the database.

28. The intellectual property management method of claim 20, wherein the database is an intellectual property database.

29. The intellectual property management method of claim 20, further comprising:
providing a plurality of entries of information associated with a plurality of innovations; and
measuring the plurality of entries.

30. The intellectual property management method of claim 29, further comprising identifying users entering the plurality of entries of information associated with the plurality of innovations.

31. The intellectual property management method of claim 20, further comprising monitoring the information related to the innovation in real time.

32. The intellectual property management method of claim 20, further comprising archiving the information and the additional information associated with the innovation.

33. The intellectual property management method of claim 32, further comprising protecting the innovation from inadvertent loss.

34. The intellectual property management method of claim 32, further comprising identifying the innovation by at least one of a key word, a category, a patent and trademark office classification, a date, an industry, a standard industrial classification code, an identification number, and a tracking number.

35. A networked intellectual property management system, comprising:
a receiving device to receive information associated with an innovation from a user;
a database to store the information and a date the information was received at the database; and
a certification device to provide the information associated with the innovation and the date the information was stored in the database to the receiving device.

36. The networked intellectual property management system of claim 35, wherein the information associated with the innovation includes at least one of a document, an idea, and a schematic.

37. The networked intellectual property management system of claim 35, wherein the database is further to store a time the information was received.

38. The networked intellectual property management system of claim 37, wherein the certification device is further to provide the time the information was received at the database to the receiving device.

39. The networked intellectual property management system of claim 35, wherein the certification device is further to notify a second user the information associated with the innovation was entered.

40. The networked intellectual property management system of claim 35, wherein the database is further to provide access to the information associated with the innovation to other users.

41. The networked intellectual property management system of claim 35, further comprising:
the receiving device is further to receive additional information associated with the innovation; and
the database is further to provide accesses to the information associated with the innovation and the additional information associated with the innovation simultaneously.

42. The networked intellectual property management system of claim 35, wherein the database is an intellectual property database.

43. The networked intellectual property management system of claim 35, further comprising:
a plurality of receiving devices, wherein the plurality of receiving devices are to receive a plurality of entries of information associated with a plurality of innovations from a plurality of users; and
wherein the database is further to measure the plurality of entries.

44. The networked intellectual property management system of claim 43, wherein the database is further to identify users entering the plurality of entries of information associated with the plurality of innovations.

45. The networked intellectual property management system of claim 35, wherein the database is further to monitor the information related to the innovation in real time.

46. The networked intellectual property management system of claim 35, wherein the database is further to archive the information associated with the innovation.

47. The networked intellectual property management system of claim 35, wherein the database is further to identify the innovation by at least one of a key word, a category, a patent and trademark office classification, a date, an industry, a standard industrial classification code, an identification number, and a tracking number.

48. A networked intellectual property management system, comprising:
a receiving device receiving information associated with an innovation from a user;
a second receiving device receiving additional information associated with the innovation; and
a database storing the information, a date the information was received, the additional information, and a date the additional information was received and linking the information associated with the innovation and the additional information associated with the innovation.
